(19) United States
(12) Patent Application Publication
(10) Pub. No.: US 2026/0230096 A1
(43) Pub. Date: Aug. 6, 2026

(54) ELECTRONIC DEVICE SUPPORTING 5G COMMUNICATION AND 6G COMMUNICATION

(71) Applicant: Samsung Electronics Co., Ltd., Suwon-si (KR)

(72) Inventors: Yunbum LEE, Suwon-si (KR); Hyoseok NA, Suwon-si (KR); Sungchul PARK, Suwon-si (KR); Junhwa OH, Suwon-si (KR)

(21) Appl. No.: 19/380,503

(22) Filed: Nov. 5, 2025

Related U.S. Application Data
(63) Continuation of application No. PCT/KR2025/017093, filed on Oct. 24, 2025.

(30) Foreign Application Priority Data
Feb. 4, 2025 (KR) 10-2025-0013549
Mar. 19, 2025 (KR) 10-2025-0035161

(51) Int. Cl. H04B 1/00; H04B 1/40

(52) U.S. Cl. CPC H04B 1/0096; H04B 1/40

(57) ABSTRACT

An electronic device may include: at least one modem; an intermediate frequency (IF) conversion circuit configured to convert a 5G communication baseband signal from the at least one modem into an intermediate frequency signal; a 5G antenna module comprising circuitry configured to convert the intermediate frequency signal into a 5G communication radio frequency (RF) signal; a radio frequency integrated circuit (RFIC) configured to convert a 6G communication baseband signal from the at least one modem into a 6G communication RF signal.

### CROSS-REFERENCE TO RELATED APPLICATIONS

This application is a continuation of International Application No. PCT/KR2025/017093 designating the United States, filed on Oct. 24, 2025, in the Korean Intellectual Property Receiving Office and claiming priority to Korean Patent Application Nos. 10-2025-0013549, filed on Feb. 4, 2025, and 10-2025-0035161, filed on Mar. 19, 2025, in the Korean Intellectual Property Office, the disclosures of each of which are incorporated by reference herein in their entireties.

### BACKGROUND

### Field

The disclosure relates to an electronic device supporting 5th-generation (5G) communication and 6th-generation (6G) communication.

### Description of Related Art

Wireless communication technologies have been developed mainly for human services, such as voice, multimedia, and data communication. As 5th-generation (5G) communication systems are commercially available, connected devices are expected to explosively increase and to be connected to a communication network. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In the 6th-generation (6G) era, efforts are being made to develop a 6G communication system to provide various services by connecting hundreds of billions of devices and things. For this reason, the 6G communication system may be referred to as a beyond 5G system.

In the 6G communication system, the maximum transmission rate is tera (e.g., 1000 gigabit) bps, and the wireless latency is 100 microseconds (μsec). For example, the transmission rate of the 6G communication system is 50 times faster than that of the 5G communication system, and the wireless latency may be reduced to one tenth.

Techniques for ensuring coverage are being developed, including multi-antenna transmission techniques, such as new waveform, beamforming, massive multiple-input and multiple-output (MIMO), full dimensional MIMO (FD-MIMO), array antennas, or large-scale antennas, which exhibit better coverage characteristics than radio frequency (RF) devices and orthogonal frequency division multiplexing (OFDM).

For 6G communication systems to enhance frequency efficiency and system network include full-duplex technology, there are being developed full-duplex technology in which uplink and downlink simultaneously utilize the same frequency resource at the same time, network technology that comprehensively use satellite and high-altitude platform stations (HAPSs), network architecture innovation technology that enables optimization and automation of network operation and supports mobile base stations, dynamic spectrum sharing technology through collision avoidance based on prediction of spectrum usages, artificial intelligence (AI)-based communication technology that uses AI from the stage of designing and internalizes end-to-end AI supporting function to thereby optimize the system, and next-generation distributed computing technology that realizes services that exceed the limitation of the UE computation capability by ultra-high performance communication and mobile edge computing (MEC) or clouds. Further, continuous attempts have been made to reinforce connectivity between devices, further optimizing the network, prompting implementation of network entities in software, and increase the openness of wireless communication by the design of a new protocol to be used in 6G communication systems, implementation of a hardware-based security environment, development of a mechanism for safely using data, and development of technology for maintaining privacy.

Such research and development efforts for 6G communication systems would implement the next hyper-connected experience via hyper-connectivity of 6G communication systems which encompass human-thing connections as well as thing-to-thing connections. For example, the 6G communication system would be able to provide services, such as truly immersive extended reality (XR), high-fidelity mobile hologram, and digital replica. Further, services, such as remote surgery, industrial automation and emergency response would be provided through the 6G communication system thanks to enhanced security and reliability and may have various applications in medical, auto, or home appliance industries.

The above-described information may be provided as related art for the purpose of helping understanding of the disclosure. No assertion or determination is made as to whether any of the foregoing is applicable as background art in relation to the disclosure.

### SUMMARY

An electronic device may include at least one modem.

The electronic device may include an intermediate frequency (IF) conversion circuit configured to convert a 5G communication baseband signal from the at least one modem into an intermediate frequency signal.

The electronic device may include a 5G antenna module including at least one antenna configured to convert the intermediate frequency signal into a 5G communication radio frequency (RF) signal.

The electronic device may include a radio frequency integrated circuit (RFIC) configured to convert a 6G communication baseband signal from the at least one modem into a 6G communication RF signal.

The electronic device may include a flexible printed circuit board (FPCB).

The FPCB may include an intermediate frequency signal line configured to provide the intermediate frequency signal to the 5G antenna module, and a 6G communication RF signal line configured to provide the 6G communication RF signal to at least one of 6G antennas.

At least one of the 6G antennas may be disposed on the FPCB.

A flexible printed circuit board (FPCB) may include a first ground layer.

The FPCB may include a signal line layer disposed below the first ground layer.

The FPCB may include a second ground layer disposed below the signal line layer.

The FPCB may include an intermediate frequency signal line configured to provide an intermediate frequency signal of 5G communication.

The FPCB may include a 6G communication RF signal line for an RF signal of 6G communication.

The FPCB may include an antenna for the 6G communication.

The intermediate frequency signal line and the 6G communication RF signal line may be disposed in the signal line layer.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example electronic device in a network environment according to various embodiments;

FIG. 2A is a block diagram illustrating an example electronic device according to various embodiments;

FIG. 2B is a diagram illustrating an arrangement of components within an electronic device according to various embodiments;

FIG. 3 is a cross-sectional view illustrating a side structure of an FPCB according to various embodiments;

FIG. 4A is a diagram illustrating layers of an FPCB according to various embodiments;

FIG. 4B is a diagram illustrating layers of an FPCB according to various embodiments;

FIG. 5A is a cross-sectional view illustrating an arrangement between an FPCB and other elements according to various embodiments;

FIG. 5B is a cross-sectional view illustrating an example patch antenna arrangement according to various embodiments;

FIG. 5C is a cross-sectional view illustrating an arrangement between an FPCB and other elements according to various embodiments;

FIGS. 5D and 5E are graphs describing performance of a patch antenna according to various embodiments;

FIG. 5F is a cross-sectional view illustrating an example FPCB according to various embodiments;

FIG. 6A is a cross-sectional view illustrating an arrangement of a patch antenna according to various embodiments;

FIG. 6B is a diagram illustrating a second ground layer of FIG. 6A viewed from below according to various embodiments;

FIG. 6C is a diagram illustrating a second ground layer of FIG. 6A viewed from above according to various embodiments;

FIG. 7A is a cross-sectional view illustrating a patch antenna according to various embodiments;

FIG. 7B is a cross-sectional view illustrating a patch antenna according to various embodiments;

FIG. 8 is a diagram illustrating an arrangement of a patch antenna according to various embodiments;

FIG. 9 is a block diagram illustrating an example electronic device according to various embodiments;

FIG. 10 is a block diagram illustrating an electronic device according to various embodiments; and

FIG. 11 is a block diagram illustrating an electronic device according to various embodiments.

### DETAILED DESCRIPTION

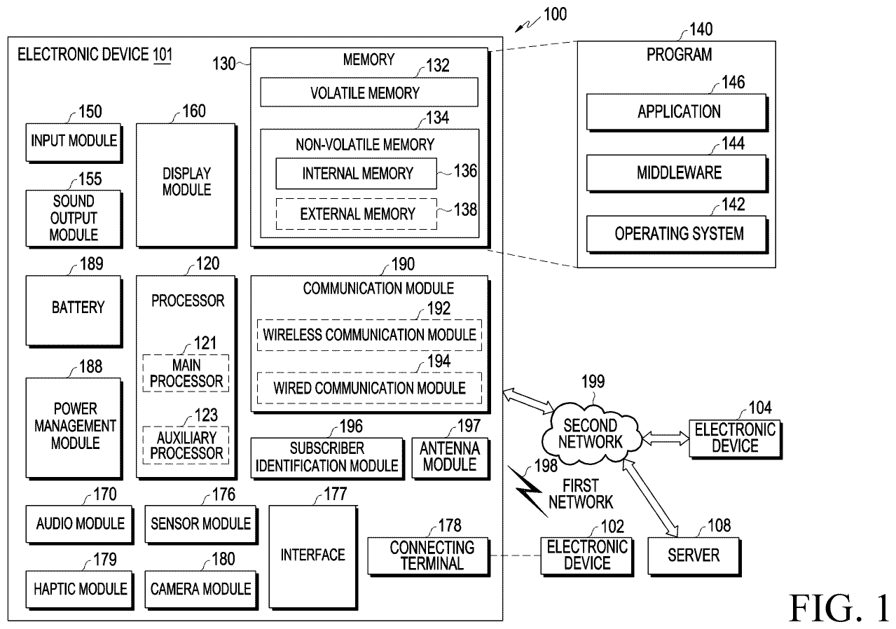

FIG. 1 is a block diagram illustrating an example electronic device in a network environment according to various embodiments;

Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the sub processor 123, the sub processor 123 may be configured to use lower power than the main processor 121 or to be specified for a designated function. The sub processor 123 may be implemented as separate from, or as part of the main processor 121. Thus, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operation state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of Ims or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

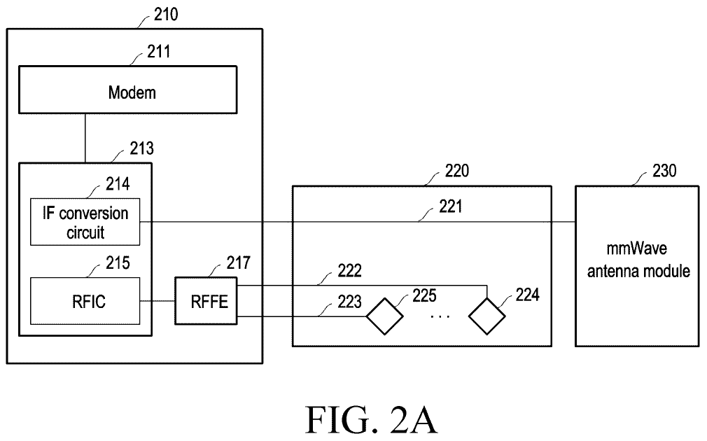

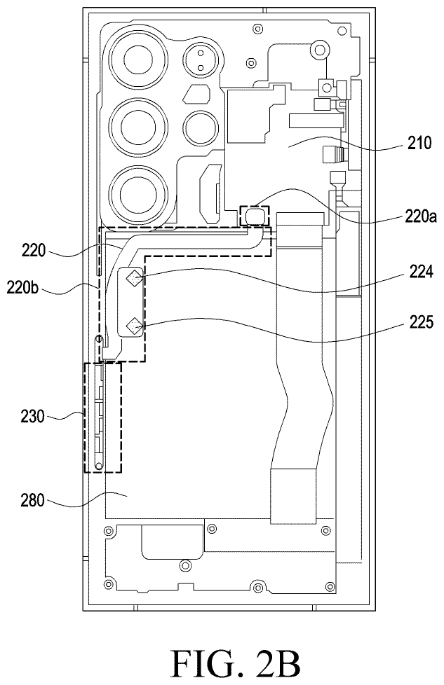

FIG. 2A is a block diagram illustrating an example configuration of an electronic device according to various embodiments. The electronic device of FIG. 2A is described with reference to FIG. 2B. FIG. 2B is a diagram illustrating an example arrangement of components within an electronic device according to various embodiments.

According to an embodiment, an electronic device 101 may include a printed circuit board (PCB) 210, a flexible printed circuit board (FPCB) 220, and/or a mmWave antenna module (e.g., including various circuitry) 230.

According to an embodiment, a modem 211, an intermediate frequency (IF)/radio frequency integrated circuit (RFIC) module 213, and/or a radio frequency front end (RFFE) 217 may be disposed on the PCB 210. The modem 211 may provide a 5G communication baseband signal and/or a 6G communication baseband signal by performing modulation. The modem 211 may be implemented to support both 5G communication and 6G communication. The modem 211 may be implemented as a plurality of modems including a modem supporting 5G communication and a modem supporting 6G communication. The modem 211 may be configured to demodulate a received baseband signal. The IF/RFIC module 213 is illustrated in FIG. 2 as including an IF conversion circuit 214 for 5G communication and an RFIC 215 for 6G communication, but this is an example, and those skilled in the art will understand that the IF conversion circuit 214 and the RFIC 215 for 6G communication may be implemented as separate pieces of hardware.

The IF conversion circuit 214 may convert a 5G communication baseband signal to an intermediate frequency signal and output the same. When 5G communication uses frequency range (FR) 2, a frequency of the intermediate frequency signal may be included in a range of, e.g., 7 GHz to 13 GHz, but the disclosure is not limited. The IF conversion circuit 214 may convert a received intermediate frequency signal to a baseband signal and provide the same to the modem 211. The RFIC 215 for 6G communication may convert a 6G communication baseband signal to a 6G communication radio frequency (RF) signal. For example, a frequency of the 6G communication RF signal may be 7 GHz or 13 GHz, but the disclosure is not limited. Accordingly, a frequency band of the intermediate frequency signal of 5G communication and a frequency band of the 6G communication RF signal may at least partially overlap, and/or a difference may be less than a threshold difference.

The frequency band of the intermediate frequency signal of 5G communication and/or the frequency band of the RF signal of 6G communication may be a relatively high frequency band, and accordingly, path loss in an intermediate frequency signal line 221 and 6G communication RF signal lines 222, 223 may also be relatively large. To suppress (or reduce) the path loss, a dielectric constant of the FPCB 220 on which an intermediate frequency signal path 221 is disposed may be implemented to have a relatively large value.

To compensate for loss in a high frequency band, a relatively high dielectric constant (or low dielectric loss) material may be used. For example, at a frequency of 13 GHz, a low dielectric loss material of about 0.5 dB to 1 dB may be used, but the disclosure is not limited on the range. For example, a dielectric loss Df value of the FPCB may be about 0.003 or less, but the disclosure is not limited.

As described above, a 6G communication RF signal that at least partially overlaps the intermediate frequency signal of 5G communication and/or has a difference less than a threshold difference may also be a relatively high frequency band, and accordingly, path loss may be relatively large. Accordingly, disposing the 6G communication RF signal lines 222, 223 on the FPCB 220 having a relatively high dielectric constant may be advantageous from a path loss perspective. For example, when an RF signal of 7 GHz or 13 GHz is provided through the 6G communication RF signal lines 222, 223, path loss of the RF signal may be relatively small due to the relatively large dielectric constant of the FPCB 220. The REFE 217 for 6G communication may process an RF signal for 6G communication provided from the RFIC 215 and provide the same to each of patch antennas 224, 225 for 6G communication. For example, the RFFE 217 may include a splitter for division into 6G communication RF signal lines 222, 223 corresponding to each of the patch antennas 224, 225, a combiner for combining received RF signals, a power amplifier, a phase shifter, a low noise amplifier, and/or a switch for transmission/reception path switching, but the disclosure is not limited. The mmWave antenna module 230 may convert an intermediate frequency signal provided through the intermediate frequency signal line 221 to an RF signal. The mmWave antenna module 230 may include, e.g., a filter, an RF local oscillator (RF LO), a mixer, an internal-branch coupler, a serial interface (serial I/F), a combiner/splitter, a phase shifter, a switch, a PA, an LNA, a coupler, and/or an antenna for 5G communication, but the disclosure is not limited. Accordingly, an RF signal for 5G communication may be provided to an antenna for 5G communication. For example, to mitigate interference between an antenna for 5G communication and patch antennas 224, 225 for 6G communication, a separation distance between the antennas may follow Equation 1.

$$d > \frac{λ}{2} \qquad [ Equation 1 ]$$

Here, λ may refer to a wavelength, and for example, in the case of 7 GHz, a minimum distance between the antennas may be about 2.2 cm, and in the case of 13 GHz, it may be about 1.1 cm, but the disclosure is not limited.

When the electronic device 101 supporting both 5G communication and 6G communication is implemented as relatively small, the electronic device 101 may additionally support legacy communication of 5G communication or less (e.g., 2G communication, 3G communication, or 4G communication), and accordingly, it may be difficult to secure space for additionally disposing an antenna for 6G communication. The patch antennas 224, 225 for 6G communication of the electronic device 101 according to various embodiments may be disposed on the FPCB 220. The FPCB 220 may connect the PCB 210 with the mmWave antenna module 230, e.g., as illustrated in FIG. 2B. For example, the FPCB 220 may be positioned on a battery 280, but the disclosure is not limited. The FPCB 220 may be disposed on the battery 280. Accordingly, the patch antennas 224, 225 for 6G communication disposed on the FPCB 220 may be disposed relatively inside the electronic device 101 when viewed from above. As the patch antennas 224, 225 are disposed relatively inside the electronic device 101, interference suppression, radiation efficiency, and/or beam forming performance may be relatively high. For example, to prevent and/or reduce degradation of radiation performance due to contact with body portions such as a user's hand or head, internal placement of the patch antennas 224, 225 may be advantageous. For example, the patch antennas 224, 225 may be disposed for radiation through a back glass to be described below. Since a non-conductive material (e.g., back glass, but not limited thereto) may be disposed on a rear surface of the electronic device 101, loss may be relatively small, and/or radiation in an omni-direction may be possible.

According to an embodiment, the FPCB 220 may include a rigid region 220a and a flexible region 220b. For example, rigidity of the rigid region 220a may be greater than that of the flexible region 220b. The rigid region 220a may be connected to the PCB 210, for example. One side of the flexible region 220a may be connected to the rigid region 220a, and the other side of the flexible region 220a may be connected to the mmWave antenna module 230.

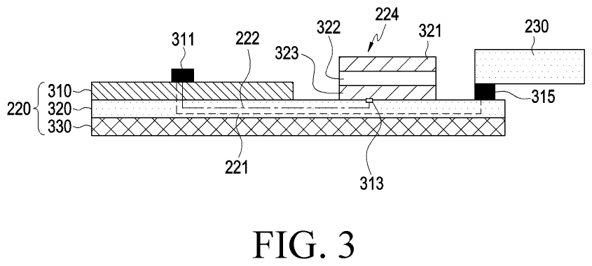

FIG. 3 is a cross-sectional view illustrating a side structure of an FPCB according to various embodiments.

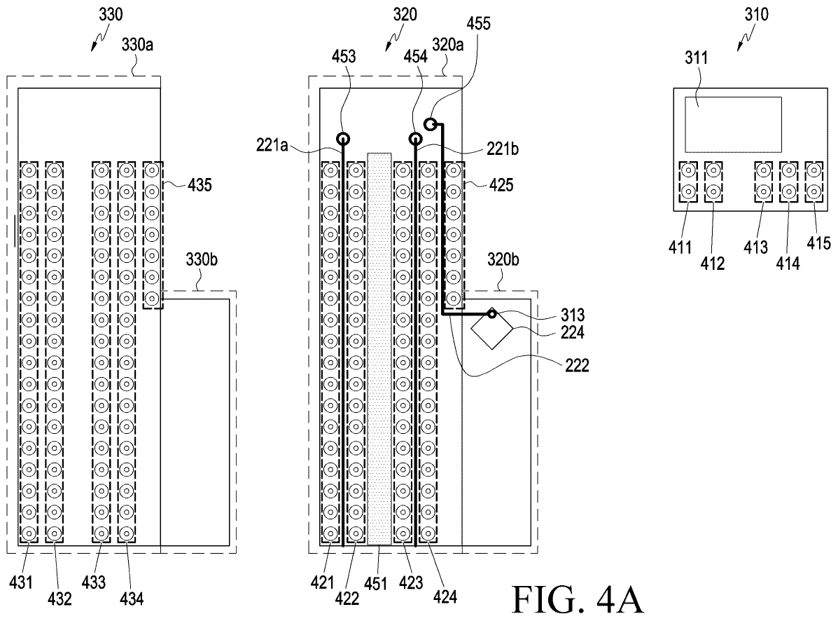

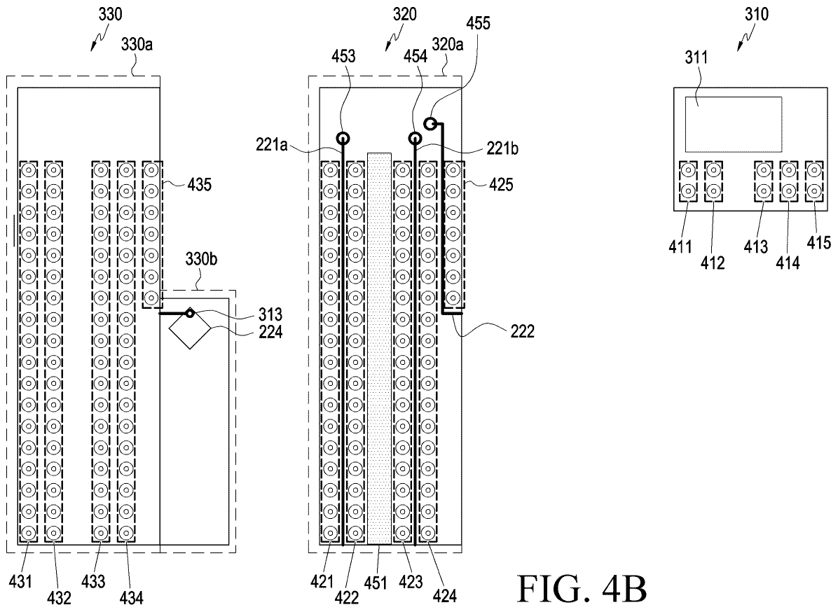

According to an embodiment, the FPCB 220 may include a first ground layer 310, a signal line layer 320, and a second ground layer 330. For example, the signal line layer 320 may be disposed on the second ground layer 330. For example, the first ground layer 310 may be disposed on the signal line layer 320. For example, the first ground layer 310 and the second ground layer 330 may be upper/lower ground layers for forming a strip line structure, but the disclosure is not limited. The first ground layer 310 may be used for grounding, for example. For example, ground vias for shielding an intermediate frequency signal and/or an RF signal of 6G communication may be connected to the first ground layer 310, which is described with reference to FIG. 4A. In FIG. 3, each of the layers 310, 320, 330 is illustrated as being in contact with each other, but this is for convenience of description, and those skilled in the art will understand that an additional layer (e.g., flexible copper clad laminate) or an adhesive member may be disposed between adjacent layers 310, 320, and/or an additional layer or adhesive member may be disposed between adjacent layers 320, 330.

For example, the first ground layer 310 may be disposed on a partial region of the signal line layer 320. The first ground layer 310 may be formed of a material for grounding, e.g., and rigidity of the first ground layer 310 may be relatively greater than rigidity of the signal line layer 320 and the second ground layer 330. As the rigidity of the first ground layer 310 is relatively high, a region where the first ground layer 310 is disposed may be included in the rigid region 220a, but the disclosure is not limited. For example, a remaining region other than a partial region of the signal line layer 320 and a partial region of the second ground layer 330 disposed below the remaining region may be included in the flexible region 220b due to their relatively low rigidity, but the disclosure is not limited. The first ground layer 310 may be disposed on a partial region of the signal line layer 320, and a patch antenna 224 for 6G communication may be disposed on at least a portion of a remaining region of the signal line layer 320. A connector 311 may be disposed on the first ground layer 310, for example. The connector 311 may be electrically connected to the IF/RFIC module 213 of the PCB 200, e.g., and accordingly, an IF signal of 5G communication and/or an RF signal of 6G communication may be provided through the connector 311.

A 6G communication RF signal line 222 may connect between the connector 311 and a feeding portion 313 of the patch antenna 224. Accordingly, an RF signal of 6G communication provided from the IF/RFIC module 213 of the PCB 200 may be provided to the patch antenna 224 through the connector 311 and the feeding portion 313. Although a portion of the 6G communication RF signal line 222 is illustrated in FIG. 3 as penetrating through an interior of the signal line layer 320, this is an example, and the disclosure is not limited on arrangement of the 6G communication RF signal line 222. An intermediate frequency signal line 221 may connect between the connector 311 and a feeding portion 315 of the mmWave antenna module 230. Accordingly, an intermediate frequency signal of 5G communication provided from the IF/RFIC module 213 of the PCB 200 may be provided to the mmWave antenna module 230 through the connector 311 and the feeding portion 315. Although a portion of the intermediate frequency signal line 221 is illustrated in FIG. 3 as penetrating through an interior of the signal line layer 320, this is an example, and the disclosure is not limited on arrangement of the intermediate frequency signal line 221. For example, ground vias for shielding an intermediate frequency signal and/or an RF signal of 6G communication may be formed in the signal line layer 320, which is described with reference to FIG. 4A.

The patch antenna 224 may be formed of a plurality of layers 321, 322, 323, for example. For example, a third layer 323 may be connected to the feeding portion 313 and accordingly may receive a 6G communication RF signal. For example, a relative dielectric constant of the third layer 323 may be about 2, but this is an example and the disclosure is not limited on the relative dielectric constant. To reduce impedance change and/or loss between the feeding portion 313 and a first layer 321 for radiation, a dielectric constant of the third layer 323 may be set relatively low, but the disclosure is not limited. A second layer 322 may be formed of a high dielectric constant material. For example, a relative dielectric constant may be about 6, but this is an example and the disclosure is not limited on the relative dielectric constant. Using a high dielectric constant material, a size of the patch antenna 224 may be formed relatively small. A first layer 321 may be a layer where radiation occurs and may be formed of a low dielectric material to enhance radiation performance, but the disclosure is not limited.

FIG. 4A is a diagram illustrating layers included in an FPCB according to various embodiments.

According to an embodiment, as described with reference to FIG. 3, a connector 311 may be disposed on a first ground layer 310. The connector 311 may be electrically connected to the IF/RFIC module 213 of the PCB 200, e.g., and accordingly, an IF signal of 5G communication and/or an RF signal of 6G communication may be provided through the connector 311. In the first ground layer 310, a 1-1th via ground group 411, a 1-2th via ground group 412, a 1-3th via ground group 413, a 1-4th via ground group 414, and/or a 1-5th via ground group 415 may be disposed (or formed). The connector 311 may be connected to a plurality of connection portions 453, 454, 455 of the signal line layer 320, for example. For example, a first intermediate frequency signal of 5G communication may be provided from the PCB 210 through the connector 311 and provided to a first intermediate frequency signal line 221a through a connection portion 453. A second intermediate frequency signal of 5G communication may be provided from the PCB 210 through the connector 311 and provided to a second intermediate frequency signal line 221b through a connection portion 454. An RF signal of 6G communication may be provided from the PCB 210 through the connector 311 and provided to a 6G communication RF signal line 222 through a connection portion 455. The RF signal of 6G communication may be provided to a patch antenna 424 through the RF signal line 222. In FIG. 4A, one patch antenna 424 and a corresponding RF signal line 222 are illustrated, but this is for convenience of description, and those skilled in the art will understand that another patch antenna, an RF signal line corresponding to each other patch antenna, and a feeding portion may be disposed in the signal line layer 320.

A 2-1th ground via group 421 may be disposed on one side of the first intermediate frequency signal line 221a. For example, a portion of the 2-1th ground via group 421 may be connected to the 1-1th via ground group 411. A 2-2th ground via group 422 may be disposed on the other side of the first intermediate frequency signal line 221a. For example, a portion of the 2-2th ground via group 422 may be connected to the 1-2th via ground group 412. Accordingly, the first intermediate frequency signal may be shielded by the 2-1th ground via group 421 and the 2-2th ground via group 422. A 2-3th ground via group 423 may be disposed on one side of the second intermediate frequency signal line 221b. For example, a portion of the 2-3th ground via group 423 may be connected to the 1-3th via ground group 411. A 2-4th ground via group 424 may be disposed on the other side of the second intermediate frequency signal line 221b. For example, a portion of the 2-4th ground via group 424 may be connected to the 1-4th via ground group 414. Accordingly, the second intermediate frequency signal may be shielded by the 2-3th ground via group 423 and the 2-4th ground via group 424. For example, a main power line (which may be named VPH) 451 may be disposed between the 2-2th ground via group 422 and the 2-3th ground via group 423.

A 6G communication RF signal line 222 may be disposed between the 2-4th ground via group 424 and a 2-5th ground via group 425. The 2-5th ground via group 425 may be connected to the 1-5th ground via group 415. Accordingly, the 6G communication RF signal may be shielded by the 2-4th ground via group 424 and the 2-5th ground via group 425. The 2-4th ground via group 424 may be used for shielding the second intermediate frequency signal and for shielding the 6G communication RF signal, and this may be named a shared ground via group. According to an embodiment, at least some of a plurality of ground vias may be shared for shielding a plurality of signals (e.g., the second intermediate frequency signal and the 6G communication RF signal), and accordingly, an increase in the number of ground vias may be suppressed and an increase in area of the FPCB 210 may be suppressed.

According to an embodiment, the signal line layer 320 may include a 2-1th sub-region 320a and a 2-2th sub-region 320b. The plurality of signal lines 221a, 221b, 222 may be disposed in the 2-1th sub-region 320a. A patch antenna 224 for 6G communication may be disposed in the 2-2th sub-region 320b. In that it is formed for the patch antenna 224, the 2-2th sub-region 320b may be named an extended region, but the disclosure is not limited. A region of the signal line layer 320 disposed below the first ground 310 may be included in the 2-1th sub-region 320a and may not be included in the 2-2th sub-region 320b. The 2-2th sub-region 320b may be a fill-cut region, for example. The 3-2 sub-region 330b may include a ground, but this is an example and the disclosure is not limited.

The second ground layer 330 may include a 3-1th sub-region 330a and a 3-2th sub-region 330b. The 2-1th sub-region 320a may be disposed on the 3-1th sub-region 330a, and the 2-2th sub-region 320b may be disposed on the 3-2th sub-region 330b. The plurality of via ground groups 431, 432, 433, 434, 435 may be disposed (or formed) on the 3-1th sub-region 330a. Each of the plurality of via ground groups 431, 432, 433, 434 of the second ground layer 330 may be connected to the plurality of via ground groups 421, 422, 423, 424, 425 of the signal line layer 320, but the disclosure is not limited.

FIG. 4B is a diagram illustrating layers included in an FPCB according to various embodiments.

A patch antenna 224 may be disposed on a 3-2th sub-region 330b of the second ground layer 330 rather than the signal line layer 320. In this case, the 2-2th sub-region 320b of the signal line layer 320 of FIG. 4A may not be present. For example, the 6G communication RF signal line 222 of the signal line layer 320 may be connected to the patch antenna 224 disposed on the 3-2th sub-region 330b through a via, for example.

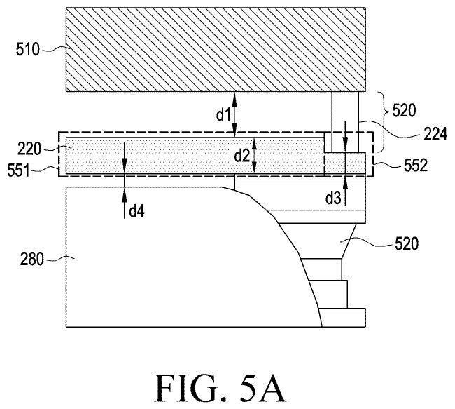

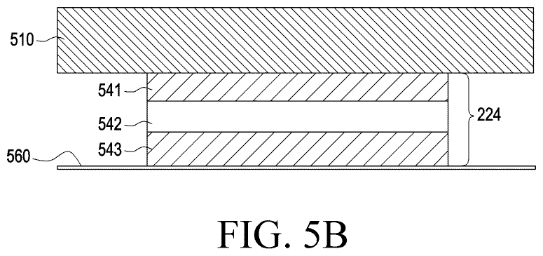

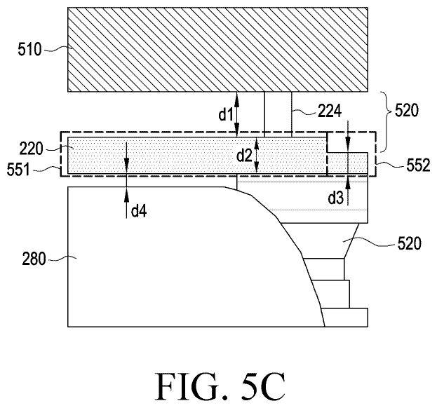

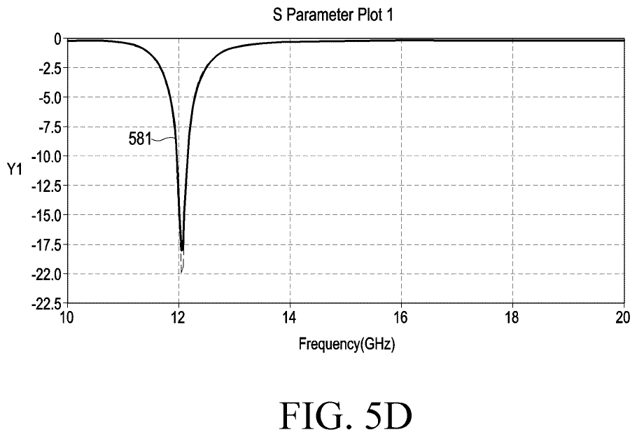

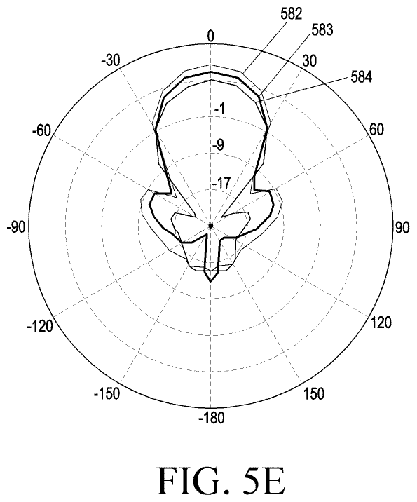

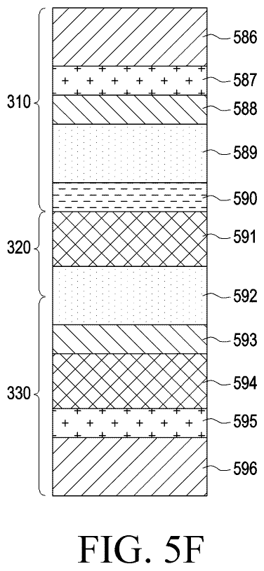

FIG. 5A is a cross-sectional view illustrating an arrangement between an FPCB and other elements according to various embodiments. The arrangement of FIG. 5A is described with reference to FIG. 5B. FIG. 5B is a cross-sectional view illustrating a patch antenna arrangement according to various embodiments.

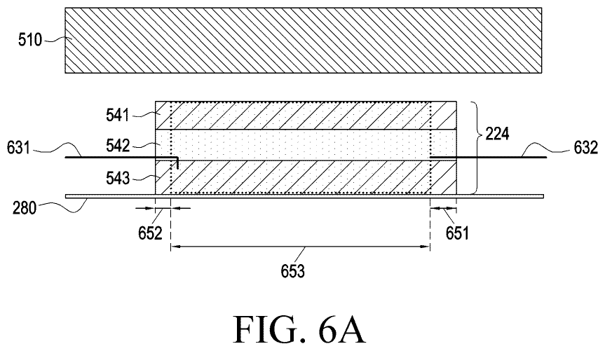

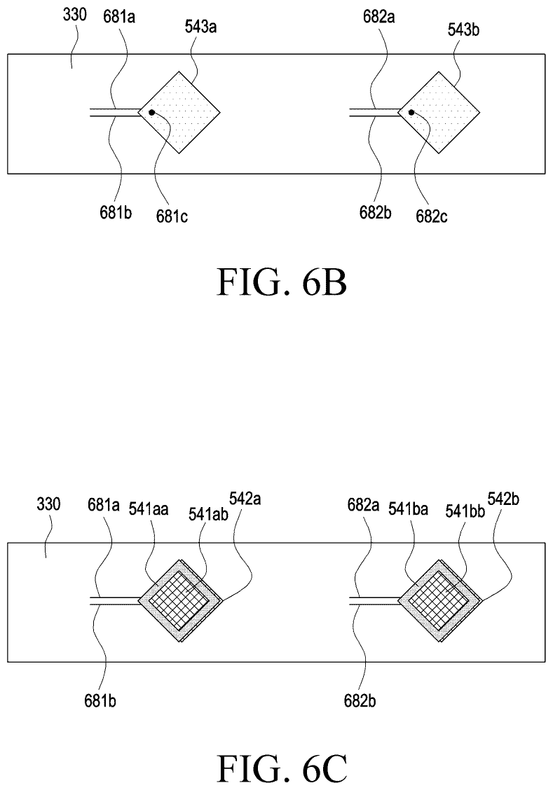

According to an embodiment, the FPCB 220 may be supported by a support structure 520, for example. The FPCB 220 may include a first region 551 and a second region 552, for example. A back glass 510 of the electronic device 101 may be disposed to be spaced apart from the first region 551 of the FPCB 220 by d1. A thickness of the first region 551 of the FPCB 220 may be d2, for example. A thickness of the second region 552 of the FPCB 220 may be d3, for example. For example, in FIG. 4A, the second region 552 may include two layers 320, 330, or in FIG. 4B, the second region 552 may include one layer 330. A region between the second region 552 and the back glass 510 may be named an air region 520. A patch antenna 224 may be disposed in the air region 520, as illustrated in FIG. 4A or FIG. 4B. For example, a vertical length of the air region 520 may be d1+d2−d3, and accordingly, a thickness of the patch antenna 224 may be set to d1+d2−d3 or less. For example, as illustrated in FIG. 5B, the patch antenna 224 may be disposed between the back glass 510 and an upper surface 560 of the second region 552 (e.g., the signal line layer 320 in FIG. 4A, or the second ground layer 330 in FIG. 4B). In FIG. 5B, the patch antenna 224 is illustrated as being in contact with the back glass 510, but this is an example and those skilled in the art will understand that it may be spaced apart. A thickness of the patch antenna 224 may be d1+d2−d3, e.g., and it is assumed that this value is 0.8 mm. For example, d1 may be 0.5 mm, d2 may be 0.35 mm, and d3 may be 0.05 mm, and in this case, d1+d2−d3 may be 0.8 mm. In this case, a first layer 321 of the patch antenna 224 may be 0.2 mm, a second layer 322 may be 0.3 mm, and a third layer 323 may be 0.3 mm, which is an example. Referring back to FIG. 5A, a battery 280 may be positioned below the FPCB 220. A distance between the FPCB 220 and the battery 280 may be d4. For example, the patch antenna 224 may be disposed to contact the battery 280, which is described with reference to FIG. 6A. The upper surface 560 may be the second ground layer 330, e.g., in FIG. 4B. The second ground layer 330 may be used as a reflector of electromagnetic waves and/or may form a radiation pattern. As such, when the patch antenna 224 is disposed on the upper surface 560 such as the second ground layer 330, stable radiation may be possible. In FIG. 4A, the upper surface 560 may be the signal line layer 320, and in this case, stable radiation may also be possible by the second ground layer 330 disposed below the 2-2th sub-region 320b, which is a fill-cut region.

FIG. 5C is a cross-sectional view illustrating an arrangement between an FPCB and other elements according to various embodiments.

According to an embodiment, the FPCB 220 may be supported by a support structure 520, for example. The FPCB 220 may include a first region 551 and a second region 552, for example. A back glass 510 of the electronic device 101 may be disposed to be spaced apart from the first region 551 of the FPCB 220 by d1. A thickness of the first region 551 of the FPCB 220 may be d2, for example. A thickness of the second region 552 of the FPCB 220 may be d3, for example. For example, in FIG. 4A, the second region 552 may include two layers 320, 330, or in FIG. 4B, the second region 552 may include one layer 330. In FIG. 5C, the patch antenna 224 may be disposed on the first region 551. Accordingly, a thickness of the patch antenna 224 may be set to d1 or less.

FIGS. 5D and 5E are graphs describing performance of a patch antenna according to various embodiments.

Referring to FIG. 5D, an S parameter graph 581 is illustrated. For example, FIG. 5D illustrates an S parameter graph 581 for the patch antenna 224 when a frequency of an RF signal is set to 12 GHz. As illustrated in FIG. 5D, it may be identified that the S parameter graph 581 decreases at a frequency of 12 GHz. Further, referring to FIG. 5E, radiation patterns 582, 583, 584 at a plurality of frequencies (which may be, e.g., 11.6 GHz, 12 GHz, or 12.4 GHz, but the disclosure is not limited) in each coordinate system according to patch antennas according to an embodiment are illustrated. It may be identified that the radiation patterns 582, 583, 584 have relatively large values at 0 degrees, and accordingly, it may be identified that beam-forming performance is also good.

FIG. 5F is a cross-sectional view illustrating an FPCB according to various embodiments.

According to an embodiment, a patch antenna may include a stiffener layer 586, which may be kapton, e.g., but the disclosure is not limited. The stiffener layer 586 may be a protective layer for preventing/reducing damage to the FPCB during fastening, e.g., but the disclosure is not limited. An insulation layer 587 may be disposed below the stiffener layer 586, which may be photo imageable solder resist (PSR), e.g., but the disclosure is not limited. The insulation layer 587 may prevent/reduce exposure of a plating layer 588, but the disclosure is not limited. A plating layer 588 may be disposed below the insulation layer 587, which may be a copper plating layer, e.g., but the disclosure is not limited. A flexible copper clad laminate (FCCL) layer 589 may be disposed below the plating layer 588. The plating layer 588 and the FCCL layer 589 may have flexibility, and for example, a relatively thin copper plating layer may be adhered onto a polyimide film, but the disclosure is not limited. The plating layer 588 and the FCCL layer 589 may be implemented with a low loss rate material, for example. An adhesive layer 590 may be disposed below the FCCL layer 589. The adhesive layer 590 may be a layer for adhesion between adjacent layers (e.g., the FCCL layer 589 and a coverlay layer 591), but the disclosure is not limited. A coverlay layer 591 may be disposed below the adhesive layer 590. An FCCL layer 592 may be disposed below the coverlay layer 591, and the coverlay layer 591 is for protection of the FCCL layer 592, but the disclosure is not limited. A plating layer 593 may be disposed below the FCCL layer 592. The plating layer 593 and the FCCL layer 592 may have flexibility, and for example, a relatively thin copper plating layer may be adhered onto a polyimide film, but the disclosure is not limited. The plating layer 593 and the FCCL layer 592 may be implemented with a low loss rate material, for example. A coverlay layer 594 may be disposed below the plating layer 593. An insulation layer 595 may be disposed below the coverlay layer 594, which may be PSR, e.g., but the disclosure is not limited. The coverlay layer 594 is for protecting the insulation layer 595, but the disclosure is not limited. A stiffener layer 596 may be disposed below the insulation layer 595. The stiffener layer 596 may be a protective layer for preventing/reducing damage to the FPCB during fastening, but the disclosure is not limited. For example, the FCCL layer 592 may be used and/or function as a ground, but this is an example and the disclosure is not limited. The FCCL layer 592 may include a polyimide (PI) layer and/or a copper plating layer, and the PI layer and/or the copper plating layer may be used and/or function as a ground, but the disclosure is not limited. The FCCL layer 592 may include copper plating layers disposed above/below with respect to the PI layer. For example, a copper plating layer below the FCCL layer 592 may be implemented as one entity with the plating layer 593, but this is an example and the disclosure is not limited.

FIG. 6A is a cross-sectional view illustrating an arrangement of a patch antenna according to various embodiments. FIG. 6A is described with reference to FIGS. 6B and 6C.

According to an embodiment, layers 541, 542, 543 of a patch antenna 224 may be disposed on a battery 280. For example, in FIG. 6A, it is assumed that the layers 541, 542, 543 of the patch antenna 224 are disposed on a 3-2th sub-region 330b of the second ground layer 330 as illustrated in FIG. 4B, but the disclosure is not limited. For example, a first portion 631 of the second ground layer 330 may penetrate through a second layer 542 (but the disclosure is not limited thereto) and be connected to a third layer 543. As described above, a 6G communication RF signal line may be formed in the first portion 631 of the second ground layer 330, and accordingly, the 6G communication RF signal line may be connected to the third layer 543. A second portion 632 of the second ground layer 330 may penetrate through the second layer 542, for example. Inactive portions 651, 652 and an active portion 653 of the patch antenna may be distinguished based on connection points of the portions 631, 632 of the second ground layer 330, but the disclosure is not limited. For example, the active portion 653 may be determined based on a size of a radiator of the patch antenna 224. For example, the inactive portions 651, 652 may be named clearance regions. For example, the second ground layer 330 may be fill-cut, and a third layer 543 and a second layer 542 may be disposed (or bonded) on two opposite sides with respect to a fill-cut portion (e.g., at least a portion of the 3-2th sub-region 330b). Accordingly, in the inactive portions 651, 652, the second ground layer 330 may be disposed between the third layer 543 and the second layer 542, and accordingly, it may be named a clearance region.

The battery 280 may operate as a ground for radiation from the patch antenna 224. For example, a case for protection of a battery cell of the battery 280 may include a metal such as aluminum, and accordingly, a surface of the battery 280 may have conductivity, and/or continuity of surface material due to the surface of the battery 280 being relatively large may be secured, so it may serve as a reflector for radiation of electromagnetic waves. As the layers 541, 542, 543 of the patch antenna 224 are disposed on the battery 280, space between a first layer 541 of the patch antenna 224 and a back glass 510 may be secured, and/or an increase in thickness of the patch antenna may be possible.

FIG. 6B is a diagram illustrating the second ground layer 330 of FIG. 6A viewed from below according to various embodiments. Third layers 543a, 543b of a plurality of patch antennas may be disposed on a lower surface of the second ground layer 330. A 6G communication RF signal line may be connected to feeding portions 681c, 682c of the third layers 543a, 543b. Each of the 6G communication RF signal lines may be disposed between slits 681a, 681b and between slits 682a, 682b, e.g., but the disclosure is not limited, and those skilled in the art will understand that the slits 681a, 681b, 682a, 682b may be implemented not to be formed.

FIG. 6C is a view illustrating the second ground layer 330 of FIG. 6A viewed from above. Active portions 541ab, 541bb of first layers of a plurality of patch antennas, inactive portions 541aa, 541ba of the first layers, and second layers 541b, 542b may be disposed on an upper surface of the second ground layer 330, but the disclosure is not limited. According to the description, space between a first layer 541 of the patch antenna and a back glass 510 may be secured, and/or an increase in thickness of the patch antenna may be possible.

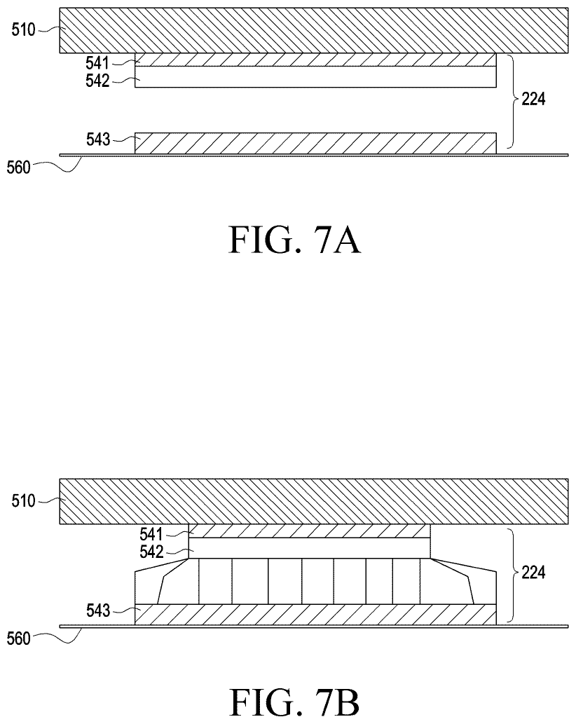

FIG. 7A is a cross-sectional view illustrating a patch antenna according to various embodiments.

According to an embodiment, a first layer 541 may be disposed on one surface of a back glass 510. A second layer 542 may be disposed below the first layer 541. For example, the patch antenna 224 of FIG. 7A may be implemented based on an electromagnetic coupling feeding method. Accordingly, a third layer 543 may be implemented to be spaced apart from the second layer 542. The third layer 543 may be connected to a 6G communication RF signal line, e.g., to receive power. The third layer 543 may feed power to at least one of the spaced layers 541, 542 based on an electromagnetic coupling feeding method, and accordingly, electromagnetic waves may be radiated from the first layer 541.

FIG. 7B is a cross-sectional view illustrating a patch antenna according to various embodiments.

According to an embodiment, a first layer 541 may be disposed on one surface of a back glass 510. A second layer 542 may be disposed below the first layer 541. For example, the patch antenna of FIG. 7A may be implemented based on an electromagnetic coupling feeding method. Accordingly, a third layer 543 may be implemented to be spaced apart from the second layer 542. In FIG. 7B, a size of the second layer 542 may be implemented to be relatively smaller than the third layer 543. For example, in an edge region of the third layer 543, an electric field may be formed in a curved direction rather than a perpendicular direction to the third layer 543 due to a fringing effect, and accordingly, the size of the second layer 542 may be implemented to be relatively small.

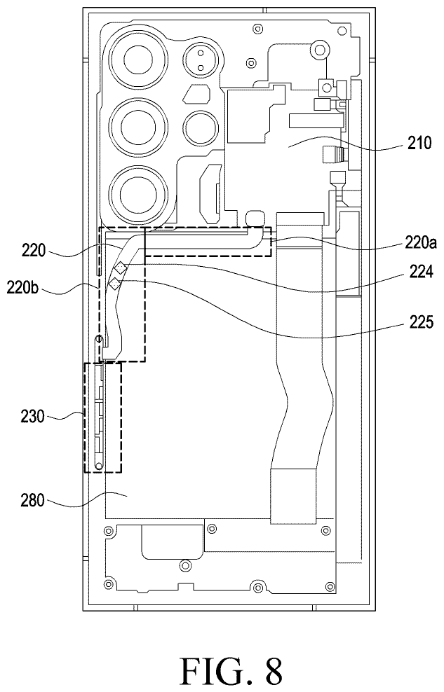

FIG. 8 is a diagram illustrating an example arrangement of a patch antenna according to various embodiments.

For example, as described with reference to FIG. 5C, patch antennas 224, 225 may be disposed on a first ground layer 310 of the FPCB 220. In this case, the FPCB 220 of FIG. 8 may be implemented in a different shape from the FPCB 220 of FIG. 2B. For example, in FIG. 2B, the patch antenna 224 may be disposed on a 2-2th sub-region 320b or a 3-2th sub-region 330b as illustrated in FIG. 4A or FIG. 4B, and accordingly, sub-regions 320a, 330a where an intermediate frequency signal line and a 6G communication RF signal line are disposed were required. However, in FIG. 8, as the patch antennas 224, 225 are disposed on the first ground layer 310, the 2-2th sub-region 320b or the 3-2th sub-region 330b as illustrated in FIG. 4A or FIG. 4B may not be required. Accordingly, a width of the FPCB 220 of FIG. 8 may be relatively smaller than a width of the FPCB 220 of FIG. 2B. However, as described with reference to FIG. 5C, as the patch antenna 224 is disposed between the first ground layer 310 and a back glass 510, a thickness of the patch antenna 224 may be set to be relatively small. A thickness of the patch antenna 224 and a width of the FPCB 220 may have a trade-off relationship, and those skilled in the art will understand that according to arrangement of elements within the electronic device 101, the arrangement of FIG. 2B or the arrangement of FIG. 8 may be selectively used.

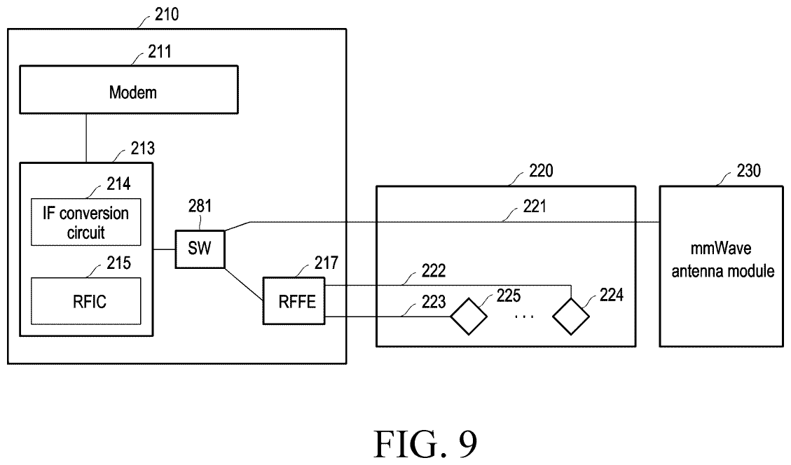

FIG. 9 is a block diagram illustrating an example configuration of an electronic device according to various embodiments.

According to an embodiment, a switch 281 may be connected to an IF/RFIC module 213 disposed on a PCB 210. The switch 281 may electrically connect the IF/RFIC module 213 to an intermediate frequency signal line 221 in a first state. The switch 281 may connect the IF/RFIC module 213 to an RFFE 217 for 6G communication in a second state. For example, while 5G communication is performed, a modem 211 (but the disclosure is not limited thereto) may control the switch 281 to the first state, and accordingly, the IF/RFIC module 213 may be connected to the intermediate frequency signal line 221. While the switch 281 is in the first state, e.g., an intermediate frequency signal for 5G communication provided from the IF/RFIC module 213 may be provided to a mmWave antenna module 230 through the intermediate frequency signal line 221. While the switch 281 is in the first state, e.g., a reception intermediate frequency signal provided from the mmWave antenna module 230 may be provided to the IF/RFIC module 213 through the intermediate frequency signal line 221. For example, while 6G communication is performed, a modem 211 (but the disclosure is not limited thereto) may control the switch 281 to the second state, and accordingly, the IF/RFIC module 213 may be electrically connected to the RFFE 217. While the switch 281 is in the second state, e.g., an RF signal for 6G communication provided from the IF/RFIC module 213 may be provided to the RFFE 217. While the switch 281 is in the second state, a reception RF signal provided from the RFFE 217 may be provided to the IF/RFIC module 213.

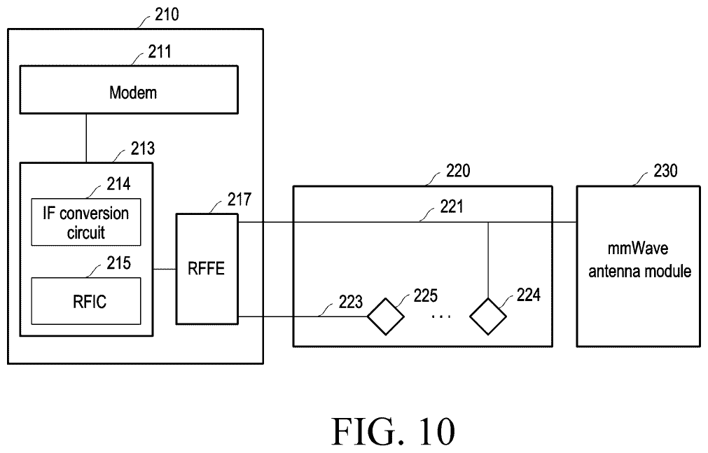

FIG. 10 is a block diagram illustrating an example configuration of an electronic device according to various embodiments.

According to an embodiment, an intermediate frequency signal line 221 may be connected to an RFFE 217, and the intermediate frequency signal line 221 may be connected to a mmWave antenna module 230 and a patch antenna 224 for 6G communication. For example, while 5G communication is performed, an intermediate frequency signal provided from an IF/RFIC module 213 may be provided to the RFFE 217. In this case, the RFFE 217 may provide an intermediate frequency signal for 5G communication to the intermediate frequency signal line 221 without performing any particular processing on the intermediate frequency signal for 5G communication. For example, the RFFE 217 may include a bypass path that does not perform processing including amplification and/or phase shift, and for example, under the control of a modem 211, may provide an intermediate frequency signal for 5G communication to the intermediate frequency signal line 221 through the bypass path. The bypass path of the RFFE 217 is an example, and those skilled in the art will understand that the disclosure is not limited on implementation that allows the RFFE 217 to provide an intermediate frequency signal for 5G communication without performing any particular processing. An intermediate frequency signal may be provided to the patch antenna 224 and the mmWave antenna module 230. For example, although an intermediate frequency signal is amplified by a driving amplifier, e.g., but is not amplified by a PA, a magnitude of electromagnetic waves radiated by the patch antenna 224 may be relatively smaller than a magnitude of electromagnetic waves radiated by an antenna for 5G communication after amplification by the mmWave antenna module 230, and accordingly, a degree of interference may be relatively small. For example, while 6G communication is performed, an RF signal for 6G communication provided from the IF/RFIC module 213 may be provided to the RFFE 217. The RFFE 217 may perform amplification and/or phase shifting for beam-forming on an RF signal and provide a processing result to the intermediate frequency signal line 221 and an RF signal line 223. An RF signal may be provided to a patch antenna 224 for 6G communication and the mmWave antenna module 230 through the intermediate frequency signal line 221. The patch antenna 224 may radiate electromagnetic waves based on a received RF signal. An operation of the mmWave antenna module 230 may be controlled by a modem 211 (but the disclosure is not limited thereto), for example. The modem 211 may control the mmWave antenna module 230 not to process a received signal while an RF signal for 6G communication is provided, and accordingly, only electromagnetic waves for 6G communication may be controlled to be radiated.

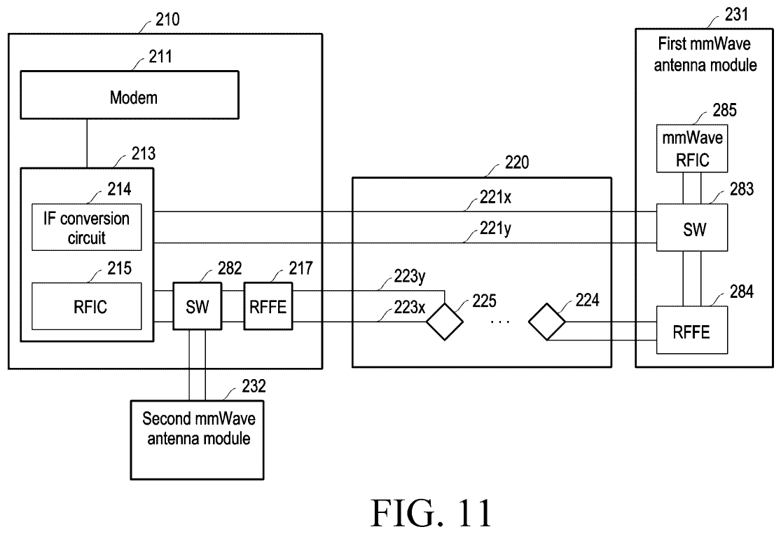

FIG. 11 is a block diagram illustrating an example configuration of an electronic device according to various embodiments.

According to an embodiment, a plurality of intermediate frequency signal lines 221x, 221y may be connected between an IF conversion circuit 214 of an IF/RFIC module 213 and a switch 283. Through the plurality of intermediate frequency signal lines 221x, 221y, intermediate frequency signals for polarization diversity may be provided, e.g., but the disclosure is not limited. The switch 283 may connect the intermediate frequency signal lines 221x, 221y to a mmWave RFIC 285 in a first state. The switch 283 may be controlled to the first state while 5G communication is performed. Each of a plurality of intermediate frequency signals provided through the intermediate frequency signal lines 221x, 221y may be converted to each of a plurality of RF signals for 5G communication by the mmWave RFIC 285. Although omitted in FIG. 11 for convenience of description, those skilled in the art will understand that amplification and/or phase shifting may be performed on a plurality of RF signals for 5G communication. The switch 283 may connect the intermediate frequency signal lines 221x, 221y to an RFFE 284 for 6G communication in a second state. The switch 283 may be controlled to the second state while 6G communication is performed. The plurality of 6G communication RF signals provided through the intermediate frequency signal lines 221x, 221y may be provided to the RFFE 284. The plurality of 6G communication RF signals may be amplified and/or phase shifted by the RFFE 284 and provided to a patch antenna 224. Elements for amplification and/or phase shifting of 6G communication RF signals and elements for amplification and/or phase shifting of 5G communication RF signals may be included in a first mmWave antenna module 231, but this is an example. Those skilled in the art will understand that at least some of elements for amplification and/or phase shifting of 6G communication RF signals may be implemented to be used for amplification and/or phase shifting of 5G communication RF signals. A switch 282 may provide intermediate frequency signals for 5G communication to a second mmWave antenna module 232 in a first state. While 5G communication is used, the switch 282 may be controlled to the first state. Intermediate frequency signals for 5G communication may be converted to RF signals, amplified, and/or phase shifted by the second mmWave antenna module 232. The switch 282 may provide RF signals for 6G communication to an RFFE 217 for 6G communication in a second state. While 6G communication is used, the switch 282 may be controlled to the second state. RF signals for 6G communication may be amplified and/or phase shifted by the RFFE 217 and provided to a patch antenna 225 through a plurality of 6G communication RF signal lines 223x, 223y. According to the description, polarization diversity for 5G communication and/or polarization diversity for 6G communication may be implemented.

An electronic device 101 may include at least one modem 211.

The electronic device 101 may include an intermediate frequency (IF) conversion circuit 214 configured to convert a 5G communication baseband signal from the at least one modem 211 into an intermediate frequency signal.

The electronic device 101 may include a 5G antenna module 230 configured to convert the intermediate frequency signal into a 5G communication radio frequency (RF) signal.

The electronic device 101 may include a radio frequency integrated circuit (RFIC) 215 configured to convert a 6G communication baseband signal from the at least one modem 211 into a 6G communication RF signal.

The electronic device 101 may include a flexible printed circuit board (FPCB) 220.

The FPCB 220 may include an intermediate frequency signal line 221 for providing the intermediate frequency signal to the 5G antenna module 230, and a 6G communication RF signal line 222, 223 for providing the 6G communication RF signal to at least one of 6G antennas.

At least one of the 6G antennas may be disposed on the FPCB 220.

The 5G antenna module 230 may be configured to amplify the converted 5G communication RF signal and provide the amplified 5G communication RF signal to an antenna for 5G communication.

The electronic device 101 may further include a radio frequency front end (RFFE) 217 configured to amplify the 6G communication RF signal and provide the amplified 6G communication RF signal to the 6G communication RF signal line 222, 223.

The FPCB 220 may have a dielectric constant included in a first range.

A loss rate of the 6G communication RF signal at the dielectric constant of the first range and a loss rate of the intermediate frequency signal at the dielectric constant of the first range may be equal to or less than a specified loss rate.

The FPCB 220 may include a first ground layer.

The FPCB 220 may include a signal line layer disposed below the first ground layer.

The FPCB 220 may include a second ground layer disposed below the signal line layer.

The intermediate frequency signal line 221 and the 6G communication RF signal line may be disposed in the signal line layer.

The electronic device 101 may further include a plurality of ground vias connecting the first ground layer, the signal line layer, and the second ground layer.

A first group among the plurality of ground vias may be disposed on a first side with respect to the intermediate frequency signal line 221.

A second group among the plurality of ground vias may be disposed on a second side opposite to the first side with respect to the intermediate frequency signal line 221.

The second group may be disposed on the first side with respect to the 6G communication RF signal line 222, 223.

A third group among the plurality of ground vias may be disposed on the second side with respect to the 6G communication RF signal line 222, 223.

The first ground layer may be disposed on a partial region of the signal line layer.

An antenna 224, 225 for the 6G communication may be disposed on a remaining region of the signal line layer except for the partial region.

The signal line layer may include a first sub-region in which a part of the intermediate frequency signal line 221 and the 6G communication RF signal lines 222, 223 are disposed and a second sub-region in which the antenna 224, 225 for the 6G communication is disposed.

The partial region may be included in the first sub-region, and the partial region may not be included in the second sub-region.

The remaining region may not be included in the first sub-region, and the remaining region may be included in the second sub-region.

The first ground layer may be disposed on a partial region of the signal line layer.

The antenna 224, 225 for the 6G communication may be disposed on a partial region of the second ground layer that is disposed below a remaining region of the signal line layer except for the partial region.

The second ground layer may include a first sub-region disposed below a part of the intermediate frequency signal line 221 and the 6G communication RF signal lines 222, 223 and a second sub-region in which the antenna 224, 225 for the 6G communication is disposed.

The partial region of the second ground layer may not be included in the first sub-region.

The partial region of the second ground layer may be included in the second sub-region.

The antenna 224, 225 for the 6G communication may be disposed on the first ground layer.

The first ground layer may be disposed on a back glass of the electronic device 101.

The signal line layer may be disposed spaced apart from the first ground layer.

The antenna 224, 225 for the 6G communication may be disposed in a fill-cut region of the FPCB.

At least two of a plurality of layers included in the antenna 224, 225 for the 6G communication may be bonded through the fill-cut region of the FPCB 220.

The antenna 224, 225 for the 6G communication may be disposed on a battery of the electronic device 101.

The intermediate frequency signal line 221 may directly connect the IF conversion circuit 214 and the 5G antenna module 230.

The 6G communication RF signal line 222, 223 may directly connect the RFFE 217 and the antenna 224, 225 for the 6G communication.

The electronic device 101 may further include a switch connected to the IF conversion circuit 214 and the RFIC 215 for 6G communication.

The switch may be operable to connect the IF conversion circuit 214 to the intermediate frequency signal line 221 in a first state, and operable to connect the RFIC 215 to the RFFE 217 in a second state different from the first state.

A flexible printed circuit board (FPCB) 220 may be provided.

The FPCB 220 may include a first ground layer.

The FPCB 220 may include a signal line layer disposed below the first ground layer.

The FPCB 220 may include a second ground layer disposed below the signal line layer.

The FPCB 220 may include an intermediate frequency signal line 221 for providing an intermediate frequency signal of 5G communication.

The FPCB 220 may include a 6G communication RF signal line 222, 223 for a RF signal of 6G communication.

The FPCB 220 may include an antenna 224, 225 for the 6G communication.

The intermediate frequency signal line 221 and the 6G communication RF signal line 222, 223 may be disposed in the signal line layer.

The FPCB 220 may have a dielectric constant included in a first range.

A loss rate of the 6G communication RF signal at the dielectric constant of the first range and a loss rate of the intermediate frequency signal at the dielectric constant of the first range may be equal to or less than a specified loss rate.

The FPCB 220 may further include a plurality of ground vias connecting the first ground layer, the signal line layer, and the second ground layer.

A first group among the plurality of ground vias may be disposed on a first side with respect to the intermediate frequency signal line 221.

A second group among the plurality of ground vias may be disposed on a second side opposite to the first side with respect to the intermediate frequency signal line 221.

The second group may be disposed on the first side with respect to the 6G communication RF signal line 222, 223.

A third group among the plurality of ground vias may be disposed on the second side with respect to the 6G communication RF signal line 222, 223.

The first ground layer may be disposed on a partial region of the signal line layer.

An antenna 224, 225 for the 6G communication may be disposed on a remaining region of the signal line layer except for the partial region.

The first ground layer may be disposed on a partial region of the signal line layer.

The antenna 224, 225 for the 6G communication may be disposed on a partial region of the second ground layer that is disposed below a remaining region of the signal line layer except for the partial region.

The antenna 224, 225 for the 6G communication may be disposed on the first ground layer.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used herein, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

An embodiment of the disclosure may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The storage medium readable by the machine may be provided in the form of a non-transitory storage medium. Wherein, the “non-transitory” storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities. Some of the plurality of entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device comprising:
at least one modem;
an intermediate frequency (IF) conversion circuit configured to convert a 5G communication baseband signal from the at least one modem into an intermediate frequency signal;
a 5G antenna module comprising circuitry configured to convert the intermediate frequency signal into a 5G communication radio frequency (RF) signal;
a radio frequency integrated circuit (RFIC) configured to convert a 6G communication baseband signal from the at least one modem into a 6G communication RF signal; and
a flexible printed circuit board (FPCB),
wherein the FPCB comprises an intermediate frequency signal line configured to provide the intermediate frequency signal to the 5G antenna module, and a 6G communication RF signal line configured to provide the 6G communication RF signal to at least one of 6G antennas, and
wherein at least one of the 6G antennas is disposed on the FPCB.

2. The electronic device of claim 1,
wherein the 5G antenna module is configured to amplify the converted 5G communication RF signal and provide the amplified 5G communication RF signal to an antenna for 5G communication.

3. The electronic device (101) of claim 1, further comprising:
a radio frequency front end (RFFE) comprising circuitry configured to amplify the 6G communication RF signal and provide the amplified 6G communication RF signal to the 6G communication RF signal line.

4. The electronic device of claim 1,
wherein the FPCB has a dielectric constant included in a first range, and
wherein a loss rate of the 6G communication RF signal at the dielectric constant of the first range and a loss rate of the intermediate frequency signal at the dielectric constant of the first range are equal to or less than a specified loss rate.

5. The electronic device of claim 1,
wherein the FPCB comprises:
a first ground layer;
a signal line layer disposed below the first ground layer; and
a second ground layer disposed below the signal line layer, and
wherein the intermediate frequency signal line and the 6G communication RF signal line are disposed in the signal line layer.

6. The electronic device of claim 5, further comprising:
a plurality of ground vias connecting the first ground layer, the signal line layer, and the second ground layer.

7. The electronic device of claim 6,
wherein a first group among the plurality of ground vias is disposed on a first side with respect to the intermediate frequency signal line,
wherein a second group among the plurality of ground vias is disposed on a second side opposite to the first side with respect to the intermediate frequency signal line,
wherein the second group is disposed on the first side with respect to the 6G communication RF signal line, and
wherein a third group among the plurality of ground vias is disposed on the second side with respect to the 6G communication RF signal line.

8. The electronic device of claim 5,
wherein the first ground layer is disposed on a partial region of the signal line layer, and
wherein an antenna for the 6G communication is disposed on a remaining region of the signal line layer except for the partial region.

9. The electronic device claim 8,
wherein the signal line layer comprises:
a first sub-region in which a part of the intermediate frequency signal line and the 6G communication RF signal lines are disposed; and
a second sub-region in which the antenna for the 6G communication is disposed,
wherein the partial region is included in the first sub-region and is not included in the second sub-region, and
wherein the remaining region is not included in the first sub-region and is included in the second sub-region.

10. The electronic device of claim 5,
wherein the first ground layer is disposed on a partial region of the signal line layer, and
wherein the antenna for the 6G communication is disposed on a partial region of the second ground layer disposed below a remaining region of the signal line layer except for the partial region.

11. The electronic device of claim 5,
wherein the second ground layer comprises:
a first sub-region disposed below a part of the intermediate frequency signal line and the 6G communication RF signal lines; and
a second sub-region in which the antenna for the 6G communication is disposed, and
wherein the partial region of the second ground layer is not included in the first sub-region and is included in the second sub-region.

12. The electronic device of claim 5,
wherein the antenna for the 6G communication is disposed on the first ground layer.

13. The electronic device of claim 5,
wherein the first ground layer is disposed on a back glass of the electronic device, and
wherein the signal line layer is disposed spaced apart from the first ground layer.

14. The electronic device of claim 1,
wherein the antenna for the 6G communication is disposed in a fill-cut region of the FPCB,
wherein at least two of a plurality of layers included in the antenna for the 6G communication are bonded through the fill-cut region of the FPCB, and
wherein the antenna for the 6G communication is disposed on a battery of the electronic device.

15. The electronic device of claim 1,
wherein the intermediate frequency signal line directly connects the IF conversion circuit and the 5G antenna module, and
wherein the 6G communication RF signal line directly connects the RFFE and the antenna for the 6G communication.

16. The electronic device of claim 1, further comprising:
a switch connected to the IF conversion circuit and the RFIC for 6G communication,
wherein the switch is:
operable to connect the IF conversion circuit to the intermediate frequency signal line in a first state, and
operable to connect the RFIC to the RFFE in a second state different from the first state.

17. A flexible printed circuit board (FPCB) comprising:
a first ground layer;
a signal line layer disposed below the first ground layer;
a second ground layer disposed below the signal line layer;
an intermediate frequency signal line configured to provide an intermediate frequency signal of 5G communication;
a 6G communication RF signal line for a RF signal of 6G communication; and
an antenna for the 6G communication,
wherein the intermediate frequency signal line and the 6G communication RF signal line are disposed in the signal line layer.

18. The FPCB of claim 17,
wherein the FPCB has a dielectric constant included in a first range, and
wherein a loss rate of the 6G communication RF signal at the dielectric constant of the first range and a loss rate of the intermediate frequency signal at the dielectric constant of the first range may be equal to or less than a specified loss rate.

19. The FPCB of claim 17, further comprising:
a plurality of ground vias connecting the first ground layer, the signal line layer, and the second ground layer.

20. The FPCB of claim 19,
wherein a first group among the plurality of ground vias is disposed on a first side with respect to the intermediate frequency signal line,
wherein a second group among the plurality of ground vias is disposed on a second side opposite to the first side with respect to the intermediate frequency signal line,
wherein the second group is disposed on the first side with respect to the 6G communication RF signal line, and
wherein a third group among the plurality of ground vias is disposed on the second side with respect to the 6G communication RF signal line.
